(19) United States
(12) Patent Application Publication
(10) Pub. No.: US 2026/0278129 A1
(43) Pub. Date: Sep. 17, 2026

(54) SECURITY IMPROVEMENTS WITHIN AN ENTERPRISE NETWORK

(71) Applicant: Capital One Services, LLC, McLean, VA (US)

(72) Inventor: Suraj BISHT, Flower Mound, TX (US)

(73) Assignee: Capital One Services, LLC, McLean, VA (US)

(21) Appl. No.: 19/076,990

(22) Filed: Mar. 11, 2025

(51) Int. Cl. G06F 21/62; H04L 9/40

(52) U.S. Cl. CPC G06F 21/6218; H04L 63/20

(57) ABSTRACT

Described herein are systems, methods, and programming for implementing and enforcing data authorization conditions within a computing network to improve network security. For example, in response to receiving a request for a document, an encoded copy of the document comprising an encrypted identifier can be created and provided as a response to the request. Furthermore, an event database can be updated to include an event corresponding to the request, and a notification of the event can be published to the computing network. An automated computer program can be executed to determine client device compliance with network security protocols, including submitting document validation requests to devices within the computing network, determining whether devices are in compliance with the network security protocols, and enforcing document compliance policies based on the compliance determinations.

### BACKGROUND

Within a client-server architecture, such as one used within an enterprise network, authorized clients that submit document requests to a server may receive copies of the requested documents via the server. Once the documents, or copies of those documents, are received by a client device, the server may no longer be able to track what happens with the document. For documents that include sensitive information, tracking document copy activity (e.g., downloads, copies, etc.) is particularly important to ensure components of the enterprise network adhere to the network's security protocols and enterprise information retention policies.

### SUMMARY

Methods and systems are described herein for novel uses and/or improvements for implementing and enforcing data authorization conditions within a computing network. These technical solutions contribute to a technical benefit of improving network security. For example, by tracking document retrieval requests and responses across the computing network, the technical solutions described herein overcome technical problems associated with computing networks and network security. More specifically, the technical solutions described herein improve network security of computing networks (such as enterprise networks) by monitoring document transactions using embedded encodings. These embedded encodings can enable document copies to be tracked within a computing network. Furthermore, these embedding encodings can enable automated computer programs to determine whether client devices are in violation of data authorization conditions and enforcing those conditions to violating devices.

Within computing networks employing a client-server architecture (or similar architectures), such as enterprise networks, technical problems exist with respect to tracking document copies across the network. For example, some example networks storing documents including sensitive information may lack procedures to track copies of those documents. As another example, some example networks lack procedures to verify ownership and validity of document copies (i.e., documents including sensitive information) stored on networked client devices. As yet another example, some example networks lack procedures to enforce data authorization conditions across the network as specified for the original document. In other words, because of the difficulty or lack of document copy tracking within the network, challenges exist in identifying the correct enforcement policies to be applied when violations are detected due to difficulties in determining the corresponding original document associated with that (violating) document copy.

The technical solutions described herein include a tracking component and an enforcement component. In addition, an agent component is described that enables certain components of a computing network to execute tracking/enforcement procedures automatically and/or in conjunction with a centralized process. These technical solutions enable documents to be tracked within a computing network, such as an enterprise network, automatically. Furthermore, these technical solutions enable information retention policies (IRPs)/document retention policies (DRPs) for the enterprise network to be enforced automatically. Doing so can provide document integrity and ensure client device compliance to network security protocols, improving network security of the enterprise network, the client devices and other components of the network, and the documents and other data stored by the network.

In some embodiments, documents, and more specifically, document copies, may be requested and provided to components of a computing network, such as an enterprise network. The document requests can include short-term requests (e.g., seconds, minutes) or longer-term requests (e.g., days, weeks). Some (or all) of these documents may include sensitive information, such as private/confidential information (e.g., account numbers, identification information, communication information, etc.), making it vital that these documents are properly tracked as they move around the network.

Within an enterprise network, entitled devices and non-entitled clients may both request and receive documents and/or other data based on security protocols of the network. For example, an entitled client device may be authorized to access specific resources, services, or data based on enterprise policies, often using authentication and security mechanisms. A non-entitled client device may lack the same authorizations and may be restricted from accessing sensitive enterprise resources, instead being limited to public or less secure network areas. However, non-entitled client devices may still obtain access to documents that include sensitive information. For example, artificial intelligence/machine learning/large language models may be processed on documents that, unknowingly, include sensitive information. As another example, some models may be authorized to access the documents including sensitive information but may not be authorized to perform other operations (e.g., generate additional copies, share the additional copies, modify their stored copy, etc.) to the documents. As these situations increase, technical solutions are needed to automate processes to track and enforce network security policies, thereby minimizing and/or eliminating the impact of possible security violations.

In some embodiments, the technical solutions may include providing document copies to client devices including encrypted identifiers. When a document retrieval request is received, a unique document identifier—an encrypted identifier—can be created for a copy of the document. The unique document identifier can be incorporated into the document (e.g., using embedded text, metadata, a barcode, a QR code, etc.) and provided—as an encoded copy of the document—to the requesting client device. Furthermore, in response to the document retrieval request and/or the providing of the encoded copy of the document to the client device, an event may be created and an event notification of the event can be published to an event log including the associated details. Furthermore, other events associated with other document transactions can also be published to the event log. For example, any instance of a document copy being created—either from a document retrieval request or by a client device—can have a corresponding event notification published to the event log indicating the details of that transaction. These details can include details such as the requesting client device, the destination client device (if different). In some examples, the event can include an event mapping of the encrypted identifier to the reference identifier. In some examples, the events stored in the event log may include an event identifier (e.g., a unique identifier for the event), a timestamp of the event (e.g., when the document retrieval request was received, when the document copy was created, when the document copy was provided to the requesting device, etc.), a requesting device identifier, a requesting document identifier (e.g., the document specified in the document retrieval request), or other information. Furthermore, as detailed below, the event log can also be used to publish compliant/non-compliant client devices, when violations occur, and when enforcements are applied.

In some embodiments, the technical solutions may also include deploying and executing an automated computer program that is configured to fetch document retrieval histories and stored client documents to determine when client devices are in violation of IRPs/DRPs. For example, the automated computer program (i.e., a crawler software application) may retrieve updates to the event log as well as scan document copies stored in client memories. The automated computer program may be designed to automatically access information stored on a client device by leveraging system permissions, APIs, and/or network protocols to scan, index, and retrieve structured and/or unstructured data. In some embodiments, the automated computer program may follow predefined rules or machine learning-based heuristics to identify and extract relevant document information, metadata, or other content (e.g., document identifiers) while adhering to security and access control policies.

As an example, the automated computer program may access documents stored in accessible memory of a client device. The automated computer program may, in some cases, deploy software and/or a machine learning model to scan the documents stored in memory and determine whether those documents include any document identifiers. For example, an OCR reader may be applied to a stored document to determine and extract, if present, a document identifier from the document. The extracted document identifier can then be compared to encrypted identifiers of document copies included in document transactions across the network. As each document transaction has an encrypted identifier generated when a document copy is created, the extracted document identifier can be determined to be one of the previously generated encrypted identifiers. Using the identified encrypted identifier, a reference identifier of a document mapped to the encrypted identifier can be determined and, subsequently, one or more data authorization conditions associated with that document can be identified. The data authorization conditions for the document can be applied to the encoded copy of the document detected on the client device. If that document copy complies with the data authorization conditions, the document copy may remain with the client device. For example, a notification (e.g., a message displayed within a graphical user interface) may be provided to the client device to indicate that the document copy complies with security protocols. Alternatively, if it is determined that the document copy does not comply with one or more of the data authorization conditions, then that client device may be classified as being in violation of the security protocols. Client devices determined to be in violation of security protocols can have various actions performed. For example, non-compliant devices can have the violating document copy deleted from their memory.

In some aspects, systems, methods, and programming for implementing and enforcing data authorization conditions within a computing network to improve network security are described. In some examples, a request for a document may be received from a client device of a computing network. An encoded copy of the document, including an encrypted identifier, may be generated and provided to the client device as a response to the request. An event database may be updated to include an event corresponding to the request. The event may include (1) an event mapping of the encrypted identifier to the document and (2) a device identifier of the client device and a notification of the event may be provided to the computing network.

In some aspects, subsequent to the notification being provided to the computing network, an automated computer program may be executed. The automated computer program may determine whether the client device complies with one or more security protocols of the computing network. Based on the automated computer program, an extracted document identifier of a document stored in memory of the client device may be received from the client device. Based on the extracted document identifier matching the encrypted identifier, a data authorization condition associated with the document may be retrieved. Based on the data authorization condition, a data authorization result indicating that the client device complies or fails to comply with the one or more security protocols may be determined and a document compliance notification may be provided ; to the client device based on the data authorization result.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for tracking and enforcing data authorization conditions in a computing network, in accordance with one or more embodiments.

FIGS. 2A-2D show illustrative diagrams of data stored by databases of the computing network, in accordance with one or more embodiments.

FIG. 3 is an illustrative diagram of an example event log, in accordance with one or more embodiments.

FIG. 4 shows illustrative components of a system used to track and enforce data authorization conditions in a computing network, in accordance with one or more embodiments.

FIG. 5 shows an illustrative flowchart of an example process for tracking documents and compliance within a computing network, in accordance with one or more embodiments.

FIG. 6 shows an illustrative flowchart of an example process for determining a data authorization result for data authorization condition enforcement, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

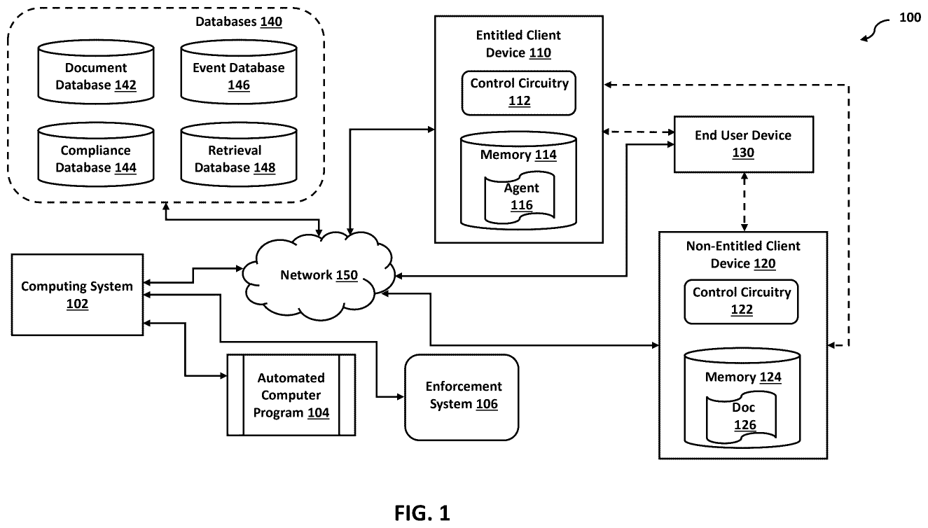

FIG. 1 shows an illustrative system 100 for tracking and enforcing data authorization conditions in a computing network, in accordance with one or more embodiments. For example, system 100 may include a computing system 102 configured to track documents within system 100, determine whether client devices comply with data authorization conditions, and enforce policies for client devices that fail to comply with the data authorization condition. In some embodiments, computing system 102 may leverage an automated computer program (e.g., automated computer program 104) for monitoring/tracking documents. For example, computing system 102 may deploy, host, update, or otherwise control automated computer program 104. In some embodiments, computing system 102 may leverage an enforcement system (e.g., an enforcement system 106) for enforcing security protocols. For example, computing system 102 may instruct or otherwise enable enforcement system 106 to enforce document/information retention policies forming security protocols for system 100.

System 100 is also referred to as a computing network. One example computing network is an enterprise network. An enterprise network operates by integrating various computing systems, client devices, and databases to facilitate secure and efficient data access and communication. Computing system 102, in the example of an enterprise network, can be referred to as an enterprise system. In this example, the enterprise network can be an integrated software platform that centralizes and streamlines core business processes, data, and workflows across an organization.

In these examples, computing system 102, which may be a server or have a cloud-based infrastructure, may be configured to process requests, manage authentication/compliance, and enforce security protocols with components of system 100. For example, system 100 may include one or more entitled client devices (e.g., entitled client device 110), one or more non-entitled client devices (e.g., non-entitled client device 120), one or more end user devices (e.g., end user device 130), one or more databases (e.g., databases 140), or other components. In some embodiments, components of system 100 may communicate with one another using network 150 (e.g., the Internet). In some examples, components of system 100 can communicate with one another directly (e.g., via a shared or wired connection).

As described herein, an entitled client device, such as entitled client device 110, refers to a computing device (which may include a mobile computing device) that connects to computing system 102 with approved/active user credentials. Entitled client device 110 may be authorized to access an enterprise system, such as computing system 102 (and can include access to one or more of databases 140), based on user credentials, security policies, device compliance checks, or other techniques, as described herein. Entitled client device 110 can be granted permissions to interact with enterprise resources, such as databases (e.g., databases 140), applications, and/or network services. In some examples, entitled client device 110 can store authentication data used to comply with enterprise security protocols. The authentication data can be used to provide access to restricted resources based on predefined permissions (e.g., documents that store sensitive information). In some embodiments, entitled client device 110 includes authorization/permission to retrieve/access documents stored in document database 142, as described further below. In particular, accounts associated with entitled client devices, such as entitled client device 110, may be used to access account-owned documents (e.g., documents that are owned, created, assigned, linked to, etc., that account). In some embodiments, entitled client devices (e.g., entitled client device 110) may be authorized to store documents (or copies of documents) in memory (e.g., memory 114).

Entitled client device 110 may include control circuitry 112 (such as one or more processors) and memory 114. Control circuitry 112 may be configured to manage operations, execute enterprise applications, enforce security policies, and the like. Memory 114 may store software components, including an agent 116, which is a program responsible for handling authentication, policy enforcement, and secure communication with the enterprise system. Agent 116, stored in memory 114 (e.g., using RAM during execution and persistent storage, such as flash memory or a hard drive when idle), can track and enforce compliance with security protocols. In some embodiments, agent 116 can represent an enterprise agent.

Agent 116 refers to a software component or program that operates within an enterprise network, such as system 100, to facilitate communication, management, and/or data exchange between components (e.g., entitled client device 110, computing system 102, databases 140, etc.). Agent 116 may be configured to monitor, control, and/or coordinate activities across various enterprise resources (e.g., other components of system 100). Agent 116 may further be used to ensure security, compliance, and/or efficiency of components of system 100.

In contrast to entitled client devices, a non-entitled client device, such as non-entitled client device 120, may lack authorization to perform certain network operations. For example, non-entitled client device 120 may be denied access to one or more services of computing system 102 and/or data stored by databases 140. For instance, non-entitled client device 120, may be unassociated with an account of computing system 102, and accordingly may submit a request to databases 140 for a document. As another example, non-entitled client device 120 may be granted limited access to services of computing system 102 and/or data stored by databases 140. In some embodiments, aside from the entitlement differences between entitled and non-entitled client devices, non-entitled client device 120 may be substantially similar to entitled client device 110. For example, non-entitled client device 120 may include control circuitry 122 and memory 124, which may be the same or substantially similar as control circuitry 122 and memory 124, respectively, and the previous descriptions may apply. In some embodiments, differing from entitled client device 110, memory 124 may not include an agent (e.g., agent 116).

In some embodiments, non-entitled client devices may be configured to submit requests for documents. These requests, which can correspond to document retrieval requests, may include an indicator of the document being requested. This may include a reference identifier or other document identifier for the requested document. Non-entitled client device 120 may represent a device that lacks the same authorizations and permissions that entitled client device 110 has and thus may have restrictions applied to any document copy it stores. For example, non-entitled client device 120 may store a document 126 in memory 124. More particularly, document 126 may correspond to an encoded copy of a document. For example, in response to a document retrieval request, non-entitled client device 120 may be provided with an encoded copy of the document specified in the request. The encoded document may be formed by generating a unique reference identifier for the document retrieval request and incorporating this identifier into the copy of the document.

End user device 130, in some embodiments, refers to a device that can be used to access services of computing system 102 and/or documents of document database 142. Differing from non-entitled client devices, end user devices (e.g., end user device 130) represent devices that can be used to access certain applications/services offered by computing system 102 and/or data stored by databases 140. In some embodiments, end user device 130 can refer to devices with which documents transactions occur or are attempted to occur to transmit encoded copies of documents by entitled client device 110 and/or non-entitled client device 120.

As illustrated in FIG. 1, entitled client device 110, non-entitled client device 120, and end user device 130 may communicate with one another, or other components of system 100, or components external to system 100, using network 150 (e.g., the Internet). In some embodiments, one or more additional security protocols may be implemented to protect data communications within system 100. For example, system 100 may include a security system (e.g., a network firewall) to monitor and control incoming and outgoing network traffic based on predefined rules to protect against unauthorized access, malware, and/or cyber threats. The security system can act as a barrier between trusted internal networks (e.g., entitled client device 110, computing system 102) and untrusted external sources. In this way, data packets can be filtered to allow or block traffic based on the prescribed security policies.

In some embodiments, however, entitled client device 110, non-entitled client device 120, and/or end user device 130 may communicate with one another directly. For example, entitled client device 110 may provide a document to end user device 130 and/or non-entitled client device 120 via a shared connection. In some cases, a document can be shared directly between entitled client device 110, non-entitled client device 120, and/or end user device 130 using peer-to-peer (P2P) communication, Wi-Fi Direct, Bluetooth, near-field communication (NFC) for short-range transfers, peer-to-peer TCP/IP connections over a local network, or others. In some examples, these document transfers may include the sending device establishing a direct connection with the receiving device, negotiating a secure handshake (e.g., using cryptographic keys or authentication protocols), and transmitting the document as a stream of data packets. Protocols like checksum verification (e.g., MD5, SHA-256) can be used for file integrity to ensure the document was received without corruption.

In some embodiments, non-entitled client device 120 and/or end user device 130 may be configured to request a document (or a copy of a document) through entitled client device 110. For example, end user device 130 may submit a document retrieval request to entitled client device 110 (through network 150 or a direct connection) and entitled client device 110 can determine whether to provide a copy of the requested document to end user device 130 based on data authorization conditions of the security protocols of system 100. If end user device 130 is authorized to receive a copy of the requested document, entitled client device 110 may provide (e.g., upon encoding and processing) the copy of the requested document to end user device 130. In some examples, the copy of the requested document is an encoded copy of the requested document (e.g., having an encrypted identifier incorporated into the copy of the document).

As described herein, a document transaction refers to any transaction that involves a document, such those described herein within system 100. For example, a document retrieval request can represent a document transaction where a device requests a copy of a document. As another example, document transactions may include shares or attempted shares of an encoded document by entitled client device 110 and/or non-entitled client device 120. Still further, document transactions can include batch retrievals by devices (i.e., in the example of non-entitled client device 120 corresponding to an analytics agent performing machine learning processing, testing, and/or validation, may retrieve documents in batches for development purposes). In this scenario, the document transaction can correspond to the individual document being provided to the non-entitled client device or the batch of documents including the document (encoded copy).

Automated computer program 104 can include automated software designed to systematically scan, retrieve, and index documents from various sources within a computer network, such as system 100. Automated computer program 104 can interface with computing system 102, databases 140, entitled client device 110, non-entitled client device 120, end user device 130, or other components of system 100, to collect and process documents. In some cases, automated computer program 104 may communicate with enforcement system 106 to determine and/or enforce one or more data authorization conditions, which can include document retention policies, information retention policies, and the like. In some embodiments, and as detailed below, automated computer program 104 can be configured to extract metadata, text, and/or structured information from one or more documents stored in local memory of a monitored device. For example, automated computer program 104 can access memory 114 to determine what, if any, documents are stored therein.

In some embodiments, copies of documents can be stored locally on client devices (e.g., document 126 stored in memory 124). As described herein, a copy of a document refers to a duplicate of a document that is able to be provided to other devices for performing one or more operations. In some examples, the copy of the document can be modifiable, however some examples include immutable copies of documents. Furthermore, in some examples, the documents (copies) stored in memory of the client devices may include encoded documents. An encoded document, as described herein, includes a document having an identifier, such as an encrypted identifier, encoded therein. The encrypted identifier can be embedded as a watermark or text, a digital representation (e.g., a QR code, a bar code), or other identifier.

In some embodiments, automated computer program 104 may communicate with entitled client device 110 using agent 116. For example, automated computer program 104 may trigger agent 116 to analyze documents stored in memory 114 and extract document identifiers encoded into those documents (if available). In some examples, automated computer program 104 can be referred to as a document crawler. As described herein, a document crawler refers to a type of automated software designed to systematically scan, retrieve, and index documents from various sources within a computing network, such as system 100. Automated computer program 104 may be configured to follow predefined paths, such as file directories, intranet portals, or cloud storage locations, to collect and process documents (i.e., copies of documents). In some cases, automated computer program 104 may be configured to search for document copies stored locally by components of the computing network, execute one or more operations to identify which documents those copies refer to, retrieve data authorization conditions associated with those documents, and determine whether the stored document copies comply with their corresponding document's data authorization conditions. If not, automated computer program 104 may further be configured to instruct an enforcement system (e.g., enforcement system 106) to enforce the data authorization conditions.

Automated computer program 104 may be triggered to analyze documents, and more particularly, document copies, stored in memory of devices of system 100. In some cases, the trigger may include a document transaction, such as a new document retrieval request, a document share, a document deletion, a document update, or other actions that cause automated computer program 104 to execute. In some embodiments, automated computer program 104 may be configured to submit document validation requests to components of system 100. A document validation request refers to a formal request to verify the authenticity, accuracy, or completeness of a document based on data authorization conditions assigned to that document (e.g., regulatory compliance, formatting standards, data integrity, retention time, etc.). The document validation requests can be used in enterprise systems to ensure that documents adhere to one or more security protocols of the computing network (e.g., system 100).

The data validation requests may be configured to enable automated computer program 104 to extract metadata, text, structured information, or other data, from one or more document copies stored in memory (e.g., memory 114, memory 124). The data validation requests may include API calls to components of system 100, where the API calls indicate the program/model/instructions to be executed by the devices to perform the validation. In some examples, the API calls may include information indicating a model to be executed, a directory to be scanned, an account number or account credentials to be used to access at least a portion of memory storing the document copies, and the like. Responses to the API calls may include document identifiers of the document copies stored in local device memory.

In some examples, as detailed below, automated computer program 104 may be configured to execute one or more models. For example, automated computer program 104 may provide or authorize cause an optical character recognition (OCR) model, an artificial intelligence model (e.g., a natural language processing (NLP) model), or another model, to be executed. Automated computer program 104 may execute the models to retrieve document identifiers from documents stored in local device memory (e.g., memory 114, 124). In some embodiments, the document copies stored in local device memory may correspond to encrypted identifiers that have been encoded into the document copies. For example, in response to a document retrieval request for a document, an encrypted identifier may be generated uniquely representing the document retrieval request, the encrypted identifier may be incorporated into a copy of the document retrieved from storage to form an encoded copy of the document, and the encoded copy may be provided to a requesting client device as a response.

In some embodiments, the different data authorization conditions can be applied to different documents based on the requesting device or the device to which the encoded copy of the document will be delivered. For example, some devices may have one or more data authorization conditions applied to any document that those devices receive/request, while other devices may have one or more other or alternative data authorizations applied to documents received/requested. As an example, an entitled client device (e.g., entitled client device 110) may have a first data authorization condition applied to any document with which it will receive a copy of, whereas a non-entitled client device (e.g., non-entitled client device 120) may have a second data authorization condition applied to any document with which it will receive a copy. In some examples, certain devices may not have any data authorization conditions applied to their documents, or may have no applied based on the corresponding device type (e.g., one or more data authorization conditions may still be applicable for the document).

When a request, such a document retrieval request, is received, computing system 102 may be configured to extract a device identifier of the requesting device and/or the device with which the document is to be transmitted (if different). Some example device identifiers include MAC addresses, IP addresses, device serial numbers, UUIDs, hardware-based security tokens, mobile telephone numbers, email addresses, and/or account numbers. Using the device identifier, a device type can be determined (e.g., a mobile device or non-mobile device, an operating system of the device, whether the device is on a secure network, etc.). Different device types can have different data authorization conditions applied to document copies, and the data authorization condition identifiers can be mapped to the device type of a requesting device via the device identifier. In some examples, data authorization conditions can be assigned to specific types of device or specific devices. For example, a certain user account may have one or more devices (e.g., entitled client devices) that are to have “stricter” data authorization conditions applied to requested documents as opposed to other devices associated with the user account. Upon extracting the device identifier from the document retrieval request, computing system 102 may determine a data authorization condition identifier (or identifiers) associated with the device identifier. Based on the data authorization condition identifier or identifiers determined to be associated with the extracted device identifier, data authorization conditions can be determined. For example, each data authorization condition identifier can refer to a particular data authorization condition to apply to copies of documents provided to the corresponding device and the encrypted identifier can be generated based on the data authorization condition.

In some examples, generating an encrypted identifier based on data authorization conditions (e.g., IRPs) can include extracting relevant metadata (e.g., a requesting device's identifier) and encoding it into a structured format. This metadata may then be modified (e.g., concatenated) with a unique identifier (e.g., a hash of the document identifier, device identifier, etc.) and processed. For example, the processing may include processing the metadata through a cryptographic hash function (e.g., SHA-256) or a symmetric encryption algorithm (e.g., AES-256) using a secret key. The resulting encrypted identifier can ensure that access control decisions can be enforced without exposing sensitive information, allowing systems to verify compliance with retention policies and authorization rules by decrypting or validating the identifier against predefined security policies.

In some embodiments, automated computer program 104 may execute a text recognition model on a document stored in memory 124 to retrieve an encrypted identifier encoded into the document. This can allow automated computer program 104, in such an enterprise environment, to track device/document compliance.

Enforcement system 106 may be configured to enforce one or more data authorization conditions. Data authorization conditions refer to the specific conditions implemented by components of the computing network (e.g., system 100) to maintain a particular level of security. Thus, the data authorization conditions form the security protocols of the computing network. Non-compliance with some or all of the data authorization conditions can cause document retention policy enforcement, which can include deletion of the document copy from the non-compliant device's memory. A client device can be considered “non-compliant” with the security protocols of the computing network based on data authorization results for data authorization conditions indicating that the client device stores a document that violates a threshold number of data authorization conditions (e.g., one condition, two conditions, all conditions, etc.) indicative of security protocol violation.

The data authorization conditions may be specific to a particular document and/or device (e.g., entitled client device 110, non-entitled client device 120, etc.). For example, a document can be assigned a data authorization condition. When a copy of the document is requested, and subsequently sent to another device, the copy of the document is to be stored in accordance with the data authorization condition. The data authorization condition may, for example, include a document retention policy/information retention policy. These policies can specify the rules for devices storing copies of documents. In some examples, the policies may differ depending on the device with which the document copy was shared. For example, a first document retention policy may be used for copies of documents shared with entitled client device 110 (e.g., unlimited document storage time) while a second document retention policy may be used for copies of documents shared with non-entitled client device 120 (e.g., allowed to store the local copy of the document for 24 hours).

In some embodiments, components of the enterprise network may be required to comply with some or all of the data authorization conditions. For example, upon registering a corresponding client device with computing system 102 (e.g., to access services available through computing system 102), the client device may agree to adhere to the data authorization conditions to remain in “good standing” in the network, and therefore able to perform the desired tasks.

When a device and/or document stored on a device is determined to not satisfy a data authorization condition, that device/document may no longer comply with one or more of the security protocols, indicating that the device is in violation of the security protocols of the network. In these instances, computing system 102 may cause, or instruct another device (e.g., enforcement system 106) to take an action to remediate the violation. In some cases, the action taken may be a warning. For example, enforcement system 106 may be configured to send a message to a device of system 100 to indicate that a stored document (e.g., a copy of a document) is in violation of a document retention policy. The message may even include steps/actions to take to remediate the violation. In some cases, multiple messages may be provided to the violating device at a particular cadence (e.g., daily, weekly, etc.). In some embodiments, after a particular number of messages (or, in certain cases, when no messages) are sent, enforcement system 106 may be configured to generate a deletion instruction, transmit the deletion instruction to the violating device, and cause the document to be deleted from the violating device using the deletion instruction.

Databases 140 may be configured to store structured and unstructured data, supporting enterprise applications (e.g., using automated computer program 104) and ensuring data consistency across all connected components (e.g., using enforcement system 106). In some embodiments, security measures like firewalls, encryption, and role-based access controls (RBAC) may be used by some or all of databases 140 to help protect sensitive information. Databases 140 may include a document database 142, a compliance database, an event database 146, a retrieval database 148, and/or other storage. While a single database is depicted for each of the aforementioned databases, persons of ordinary skill in the art will recognize that this is exemplary, and some or all of databases 140 may be implemented using a single database, a distributed database, a cloud-based database, or other databases implementations, or combinations thereof.

Document database 142 may be configured to store documents. Some of these documents may include sensitive information (e.g., private information, confidential information, etc.). For example, in the context of web browsers and web-based searches, document database 142 can store cookies, browsing histories (e.g., visited websites, login sessions, etc.), personalized preferences, and other data. As another example, in the context of mobile devices, document database 142 can store collected location data (e.g., real-time movements, frequently visited places, travel patterns), device usage data (e.g., mobile application usage, telephone usage, data usage, etc.). As yet another example, in the context of cloud storage services, document database 142 can store storage/resource consumption data, requests (e.g., document retrieval requests, document validation requests, etc.), responses to requests (e.g., documents, document copies, etc.), intellectual property, or other cloud storage data. As yet another example, in the context of financial technologies, document database 142 can store financial data for users (e.g., spending habits, merchant details, account numbers, etc.).

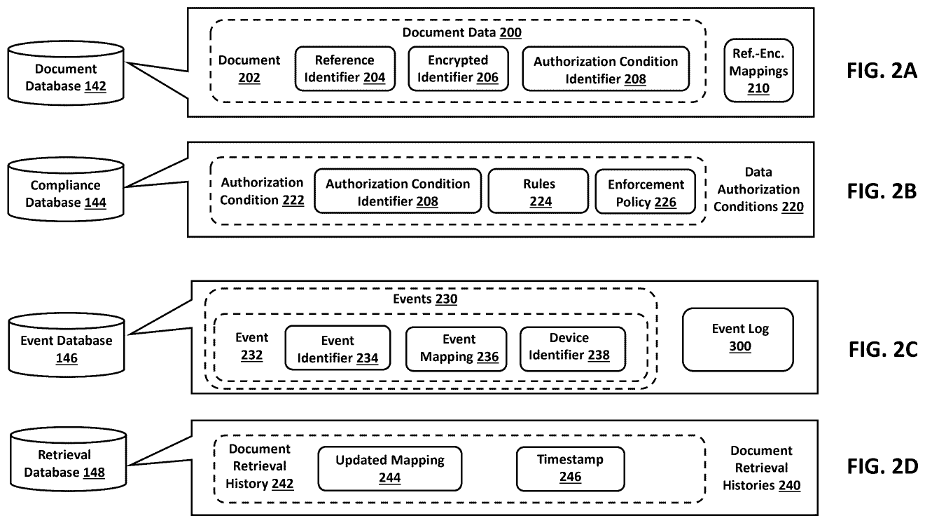

As an example, with reference to FIG. 2A, document database 142 can store document data 200. Document database 142 can operate as a structured repository for storing document data 200. Document data 200 may include data representing one or more documents, such as document 202. Document 202, as well as the other documents stored in document database 142, can be uniquely identified using a reference identifier 204. Reference identifier 204 can distinguish documents from one another. In some embodiments, when a document is first uploaded to document database 142, it can be assigned reference identifier 204. Reference identifier 204 can be static, remaining constant while stored by document database 142.

Document database 142 can store documents, such as document 202, using a combination of unstructured data, metadata, and indexing mechanisms to facilitate efficient retrieval and management. The unstructured data consists of the actual document content, such as text, images, or files in formats like PDFs and Word documents. Metadata, which can include attributes such as a creation date, author, document type, and access permissions, can help categorize and manage document data 200. In some embodiments, reference identifier 204 may include, represent, or be associated with, a location of the unstructured data forming the corresponding document (e.g., document 202). For example, reference identifier 204 may include a pointer to a memory location in document database 142 or another data repository storing the data elements forming document 202. The indexing structures used by document database 142 can enable fast searches by organizing document content and metadata for quick retrieval based on queries (e.g., document retrieval requests). Document database 142, as well as the other of databases 140, can support versioning, encryption, and access control mechanisms to enhance security and compliance within an enterprise network (e.g., system 100 of FIG. 1).

As described in greater detail below, when a document retrieval request is made, an encrypted identifier 206 can be generated. Encrypted identifier 206 can uniquely mark a copy of a given document (e.g., document 202) generated in response to a document retrieval request. Encrypted identifier 206 can be embedded into document 202 itself, creating an encoded copy that enables tracking and enforcement of data authorization conditions, as well as preventing unauthorized modifications or distribution of document copies. Document database 142 may store reference-encrypted identifier mappings 210 storing relationships between reference identifiers and encrypted identifiers for easy tracking.

In some embodiments, updated mappings may be provided to document database 142 from event database 146 and/or retrieval database 148. For example, upon determining that an encoded copy of document 202 was provided to non-entitled client device 120, automated computer program 104 and/or computing system 102 may generate an event mapping indicating that a copy of a document stored on non-entitled client device 120 matches an encrypted identifier previously generated when a copy of a document was requested. The event mapping, including a relationship between an extracted document identifier (e.g., from a copy of a document stored on a client device) and an encrypted identifier (e.g., generated in response to a document transaction may be provided to document database 142 and used to update reference-encrypted identifier mappings 210. In some embodiments, an updated mapping generated by retrieval database 148 may be provided to document database 142 and used to update reference-encrypted identifier mappings 210. For example, the updated mapping may store a relationship between the extracted document identifier, the corresponding encrypted identifier, and the reference identifier matched to the encrypted identifier.

Although a single encrypted identifier is illustrated in FIG. 2A, a given document (e.g., document 202) can include multiple encrypted identifiers, each different from one another. These encrypted identifiers are associated with each generated document copy. Thus, these encrypted identifiers can function as a proxy for a document copy's identifier. Alternatively, or additionally, the encrypted identifiers can function as a proxy for a document retrieval request's identifier.

In some embodiments, encrypted identifier 206 can be generated using a cryptographic algorithm to a unique document reference. For example, reference identifier 204 of document 202 (e.g., a UUID, a database ID, etc.) can be used to generate encrypted identifier 206 by encrypting reference identifier 204 using a symmetric or asymmetric encryption method, such as AES or RSA, along with a secret key or public-private key pair. The created encrypted identifier (e.g., encrypted identifier 206) can be used to track or verify document copies while preventing unauthorized access to the original document (e.g., document 202) or sharing the reference identifier assigned to the document. In some embodiments, additional information may be used in conjunction with, or instead of, the reference identifier (e.g., reference identifier 204) to generate the encrypted identifier (e.g., encrypted identifier 206). For example, if the encrypted identifier is generated in response to a document retrieval request, a device identifier, account identifier, request identifier, authorization condition identifier(s), or other information, can be used instead of or in addition to the reference identifier (e.g., reference identifier 204) to generate the encrypted identifier (e.g., encrypted identifier 206). As an illustrative example, if reference identifier 204 is represented as a 10-character alphanumeric string (e.g., A1B2C3D4E5), an encryption algorithm (e.g., Advanced Encryption Standard (AES)-256 encryption) can be used with a secret key (e.g., MySecretKey12445) to create encrypted identifier 206 (e.g., 7F8G92KLMN). Although AES-256 encryption is described in the previous example, other encryption techniques, including, but not limited to, Rivest-Shamir-Adleman (RSA), Data Encryption Standard (DES), Triple DES (3DES), Elliptic Curve Cryptography (ECC), and/or Blowfish.

Additionally, some or all of the documents stored in document database 142 can include an authorization condition identifier 208. Authorization condition identifier 208 can indicate one or more data authorization conditions assigned to document 202. These conditions specify how the document (e.g., document 202) can be shared, stored, modified, or otherwise used, within an enterprise network (e.g., system 100 of FIG. 1). For instance, certain documents may be restricted and only accessible to users that own or have access rights to that document. For example, an entitled client device (e.g., entitled client device 110) may represent a device that owns or has access rights to one or more documents stored by document database 142. On the other hand, a non-entitled client device (e.g., non-entitled client device 120) may represent a device that does not own a given document but may be authorized to receive a copy of that document. That copy, however, may inherit some or all of the data authorization conditions associated with its source document (e.g., how the shared copy of the document can be used, stored, modified, or otherwise accessed, by the non-entitled client device).

As an example, authorization condition identifier 208 can correspond to a data authorization condition associated with document 202 specifying how long a copy of document 202 is allowed to be stored locally by a non-entitled (or entitled) client device. As another example, authorization condition identifier 208 can correspond to a data authorization condition associated with document 202 that specifies which, if any, client devices (e.g., entitled, non-entitled, end user devices) the copy of the document can further be provided. For instance, a requesting client device may be authorized to receive a copy of a document (i.e., an encoded copy including encrypted identifier 206), but may not be authorized to further transmit generate an additional copy of the document (using their copied version) and/or send that additional copy to another device (e.g., non-entitled client device 120 may not be allowed to generate and share an additional copy of document 126). As with encrypted identifier 206, although a single instance of authorization condition identifier 208 is depicted for document 202, persons of ordinary skill in the art will recognize that a given document can include one or more data authorization conditions and therefore a given document or copy of the document can include one or more data authorization condition identifiers corresponding to those data authorization conditions.

Compliance database 144 may be configured to store data authorization conditions used to verify client device compliance with security protocols of an enterprise network (e.g., system 100 including devices 110, 120, 130). As an example, with reference to FIG. 2B, compliance database 144 may store data authorization conditions 220. Data authorization conditions 220 may represent security protocols for a computing network (e.g., system 100). Different data authorization conditions can be stored by compliance database 144 using authorization condition identifiers (e.g., authorization condition identifier 208) and can be applied to different documents and/or different client devices. For example, a first copy of a document can have a first data authorization condition assigned based on the first copy being provided to entitled client device 110 while a second copy of the document can have a second data authorization condition assigned based on the second copy being provided to non-entitled client device 120. In some embodiments, compliance database may store device-condition mappings that includes a mapping of a device identifier of a device within system 100 (e.g., entitled client device 110, non-entitled client device 120, end user device 130) and a data authorization condition identifier of a data authorization condition to be applied to document copies provided to that device. Different devices can have different data authorization conditions applied to document copies. The device-condition mappings can include multiple data authorization conditions for a single device identifier. Furthermore, devices can have data authorization conditions applied dynamically based on information derived from the device submitting a document retrieval request. For example, upon receiving a document retrieval request from a client device, a device identifier of the device can be extracted from the request (e.g., MAC addresses, IP addresses, device serial numbers, UUIDs, hardware-based security tokens, mobile telephone numbers, email addresses, account numbers, etc.). Using the device identifier, a device type can be determined (e.g., a mobile device or non-mobile device, an operating system of the device, whether the device is on a secure network, etc.). Different device types can have different data authorization conditions applied to document copies, and the data authorization condition identifiers can be mapped to the device type of a requesting device via the device identifier. As mentioned above, each document (e.g., document 202 of FIG. 2A) can include one or more authorization condition identifiers (e.g., authorization condition identifier 208) that point to a corresponding data authorization condition or conditions of data authorization conditions 220 stored in compliance database 144.

Data authorization conditions (e.g., data authorization condition 222) can include one or more rules (e.g., rules 224). These rules form the basis for determining whether a given document and/or client device comply with the network's security protocols. In some examples, data authorization conditions 220 can include/specify one or more document and information retention enforcement policies forming security protocols of the enterprise computing network (e.g., system 100 of FIG. 1). These document/information retention policies can ensure device compliance, data security, and efficient data management.

Rules 224 specify how a document (e.g., document 202) can remain in compliance with data authorization condition 222. For example, rules 224 can indicate a time-based retention policy, an access-controlled retention policy, a legal hold retention policy, an automated expiry and deletion retention policy, a versioning and audit log retention policy, an encryption and secure disposal retention policy, or other policies, or combinations thereof, applicable for a given data authorization condition.

In the example of data authorization condition 222 corresponding to a time-based retention policy, rules 224 may indicate that a corresponding document or, more specifically a copy of that document, (e.g., document 202) is authorized to be kept by a corresponding device (e.g., entitled client device 110, non-entitled client device 120) for a specific period of time (e.g., seven years for financial records before automatic deletion or archival). In the example of data authorization condition 222 corresponding to an access-controlled retention policy, rules 224 can indicate restrictions to document (e.g., document copy) modifications and/or deletion permissions for authorized personnel (e.g., entitled client device 110). In the example of data authorization condition 222 corresponding to an automated expiry and deletion retention policy, rules 224 can be used to minimize storage costs and security risks by purging sensitive data (e.g., document copies storing sensitive information) after a defined period. In the example of data authorization condition 222 corresponding to an encryption and secure disposal policy can ensure that document copies remain encrypted during storage (via local client device memory) and are securely erased using the appropriate enforcement policies (e.g., enforcement policy 226 implemented by enforcement system 106).

Each data authorization condition (e.g., data authorization condition 222) can include one or more enforcement policies (e.g., enforcement policy 226) that are assigned to enforce the data authorization condition. When data authorization conditions 220 are violated, one or more actions can be performed to remedy the non-compliance based on the assigned enforcement policies. In some examples, enforcement system 106 may be used to execute one or more actions based on, or in conjunction with, the enforcement policy or policies (e.g., enforcement policy 226) associated with that data authorization condition. For example, enforcement policy 226 can include causing, using enforcement system 106, events to be published to the computing network for data retrieval requests or other document transactions (e.g., shares, downloads, screenshots, etc.), sending notifications to client devices non-compliant with one or more data authorization conditions, instructing client devices to delete non-compliant document copies, deleting non-compliant document copies, or other actions, as described in greater detail herein.

In some embodiments, event database 146 may be configured to store events associated with document transactions. For example, with reference to FIG. 2C, event database 146 may store events 230. Events 230 may correspond to various document transactions occurring across the enterprise network (e.g., system 100). In some examples, events 230 may include events associated with document transactions, such as document retrieval requests. A document retrieval request refers to a request submitted by a client device to access a specific document stored in a document database. For example, entitled client device 110 may submit a document retrieval request to obtain a copy of document 202. If entitled client device 110 is an owner of the document, then computing system 102 may be configured to retrieve or create a copy of the document and send the copy to entitled client device 110. In some examples, computing system 102 may generate an encrypted identifier (e.g., encrypted identifier 206) for the document copy and generate an encoded copy of the document including the encrypted identifier. The encrypted identifier can be embedded into the document using a barcode, QR code, text, watermark, or other mechanism. As another example, if non-entitled client device 120 submits a document retrieval request for a copy of document 202, computing system 102 may determine whether non-entitled client device 120 has permission to access a copy of the document, which may include providing a unique code or other identification information to authenticate non-entitled client device 120. Upon determining that the copy of document 202 can be provided to non-entitled client device 120, computing system 102 may generate encrypted identifier 206, send the encoded copy of document 202 including encrypted identifier 206 to non-entitled client device 120, and generate event 232 to record the document transaction. In some examples, generation of event 232 may occur in conjunction with publishing an event notification to an event log (e.g., event log 300).

In some embodiments, event database 146 stores events related to various types of document transactions, including, but not limited to, document retrieval requests, document sharing requests, document copying requests, and other access or modification activities. Each of events 230 can be logged as a unique record in event database 146, ensuring a traceable history of document usage. For simplicity, event 232 also refers to a record of the event as stored in event database 146. Events 230 can be associated with one or more devices. Each event (e.g., event 232) can include an event identifier (e.g., event identifier 234), an event mapping (e.g., event mapping 236), a device identifier (e.g., device identifier 238), or other information, or combinations thereof.

Event identifier 234 refers to an identifier for event 232. Event identifier 234 can preserve temporal information, such as when the event occurred (e.g., when the document retrieval request was submitted), location data (e.g., a location of the participating devices), session information (e.g., if the event is associated with a batch document retrieval), or other identifiers that can be used to distinguish event 232 from other events. In some embodiments, event identifier 234 may be a character string (e.g., a n-character long string).

Event mapping 236 may be used to store/link an extracted document identifier with an encrypted identifier. For example, a document identifier extracted from document 126 may be compared to encrypted identifiers included in reference-encrypted identifier mappings 210. In some embodiments, event mapping 236 can be generated based on a document transaction. For example, a document validation request may be submitted to non-entitled client device 120 to enable automated computer program 104 to access memory 124, identify one or more stored document copies (e.g., document 126), and extract document identifiers from those stored documents. Using the extracted document identifiers, automated computer program 104 can itself, or leveraging processing capabilities of computing system 102, determine whether any of the extracted document identifiers correspond to a previously-generated encrypted identifier (e.g., encrypted identifier 206). If so, the encrypted identifier can be included in event mapping 236.

Event 232 can also include a device identifier 238. Device identifier 238 can include details about the devices involved in the event (e.g., entitled client device 110, non-entitled client device 120, end user device 130). Device identifier 238 can be used to differentiate between entitled client devices (i.e., having authorized access to stored documents), non-entitled client devices (i.e., having limited access to stored documents), and end-user devices (e.g., individual user devices interacting with the encoded copy of the document). If multiple devices are involved in a given event (i.e., when a first device submits a document retrieval request for a second, different device), device identifier 238 may include multiple identifiers, each associated with a device involved in the event. Some example device identifiers include, but are not limited to, MAC addresses, IP addresses, device serial numbers, UUIDs, hardware-based security tokens, mobile telephone numbers, email addresses, account numbers, or other device identification mechanisms, or combinations thereof.

In some embodiments, event database 146 may be configured to store, host, or other provide access to, an event log (e.g., event log 300). An event log refers to a structured record of events (e.g., events 230), that occur within the enterprise network (e.g., system 100). The event log can capture details associated with the events, such as timestamps, event types, involved entities, metadata, and/or other information. As mentioned above, an event can be generated for any document transaction occurring within system 100. In an enterprise network, such as system 100, an event log (e.g., event log 300) can publish notifications representing recorded events. For example, when a document transaction occurs causing an event to be generated, an event notification can also publish to event log 300. In some examples, event log 300 may include information regarding the activities performed (e.g., document retrieval requests). Event notifications of events can be published to the event log (e.g., event log 300) by computing system 102 (e.g., using logging frameworks, message queues, etc.). Event log 300 can help track performance, detect security incidents, and ensure compliance with one or more security protocols of the enterprise network (e.g., system 100). By maintaining event log 300 as a structured data source, event database 146 can support device/document compliance auditing, access control enforcement, and security monitoring. Furthermore, the event notifications can store information useful in tracking document (e.g., encoded document copy) movement, detect unauthorized access attempts, enforce document retention and sharing policies effectively, and perform other tasks, using information derived from event log 300. Further still, the event notifications may include some or all of the event information. For example, the event notifications published to event log 300 may include an event identifier associated with an event, as well as a device identifier of a requesting device, but may not publish the event mapping.

Retrieval database 148 may be configured to store and manage changes to event database 146. In some embodiments, retrieval database 148 can store document retrieval histories. For example, as illustrated in FIG. 2D, retrieval database 148 can store document retrieval histories 240. Document retrieval histories 240 include various document retrieval tasks that have been performed in the past, updates detected from those retrievals (if any), when those retrievals occurred, as well as other information, such as updated event mappings or deltas between what was stored before and what has been added. In some embodiments, document retrieval history 242 may include one or more updated event mappings (e.g., updated mapping 244) that have been detected by a most recent document history push from event database 146. For example, in response to creating event 232, data representing event 232 may be pushed to retrieval database 148. An entry in retrieval database 148 may be created, corresponding, for example, to document retrieval history 242, storing an updated mapping generated based on the pushed event data. For example, the updated mapping may relate the event mapping with the reference-encrypted identifier mappings. In some embodiments, where the event mapping (e.g., event mapping 236) includes a relationship between an extracted document identifier and an encrypted identifier, the data representing the event can be used in conjunction with reference-encrypted identifier mappings (e.g., reference-encrypted identifier mappings 210) to link the extracted document identifier with a corresponding reference identifier (e.g., reference identifier 204).

In some embodiments, a document retrieval history (e.g., document retrieval history 242) may also include a timestamp 246 associated with updated mapping 244. In some embodiments, updated mapping 244 may include data representing events that were published to event log 300 from the last time updated data was pushed down from event database 146.

In some embodiments, retrieval database 148 can operate dynamically with document database 142, compliance database 144, and event database 146. Updated event mappings (e.g., updated mapping 244) can be pushed to retrieval database 148, ensuring real-time synchronization and accurate event tracking. This synchronization between databases can help maintain a consistent record of document access and provides important data for monitoring, security, and compliance. In some embodiments, event 232 may be pushed to document retrieval history 242 to generate updated mapping 244 using one or more event-driven mechanisms, such as message queues, database triggers, or change data capture (CDC) systems, which can be used to push the updated data.

Retrieval database 148 may also store metadata associated with the update (e.g., updated mapping 244). The metadata may include, for example, a time—represented by a timestamp 246—that is associated with document retrieval history 242. For example, a time (e.g., represented by timestamp 246) that an event occurred, a time that the update was pushed to retrieval database 148, a time that the document retrieval request was received, or other times, can be used as a reference for updated mapping 244. When an event occurs in event database 146 (e.g., a document retrieval request, modification, or sharing), an update (e.g., updated mapping 244) can be generated, and a notification of the event and/or the event itself can be published to an event log (e.g., event log 300 of FIG. 2C). In some cases, the time (e.g., represented by timestamp 246) may be provided with the published event to indicate the time associated with a most recent update (e.g., updated mapping 244). In an example, the event log refers to a message log, which may be implemented using a messaging system (e.g., Kafka, RabbitMQ, a webhook-based notification service, etc.). Retrieval database 148 can monitor for these updates and process them in real time, ensuring that any changes to the event log (e.g., event log 300) are reflected. This push mechanism helps maintain synchronization across the enterprise network (e.g., system 100), ensuring consistent, up-to-date document retrieval.

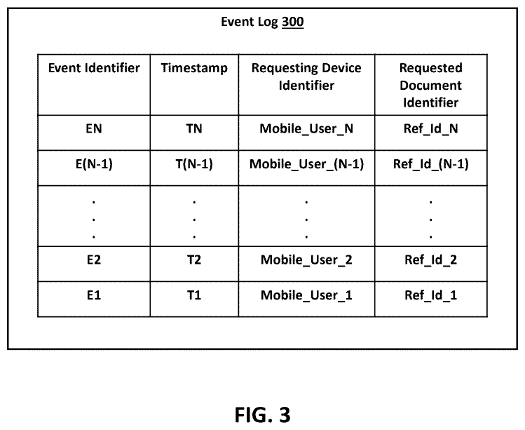

FIG. 3 is an illustrative diagram of an example event log 300, in accordance with one or more embodiments. In some embodiments, event log 300 of FIG. 3 is an example of event log 300 described in FIG. 2C. In some embodiments, event database 146 may be configured to store, host, or other provide access to, an event log (e.g., event log 300). As described herein, an event log refers to a structured record of events that occur within the enterprise network (e.g., system 100). The event log can capture details associated with the events, such as event identifiers, timestamps, event types (e.g., document retrieval requests, access attempts, modifications, system errors, etc.), involved devices (e.g., requesting device, destination device, source user account, etc.), a requested document (e.g., a reference identifier included in the submitted document retrieval request), and/or other information. In some embodiments, the event log can publish event notifications, which represent the corresponding events. The event notifications may include some or all of the information included in the event record stored in event database 146 (e.g., as part of events 230). For example, the event notifications may include an event identifier and a device identifier but may not include an event mapping of the extracted document identifier with its corresponding encrypted identifier.

As mentioned above, an event can be generated for any document transaction. In an enterprise network, such as system 100, event log 300 can record events including activities like document retrieval requests, access attempts, modifications, system errors, or others. Event notifications can be published to event log 300 by computing system 102 (e.g., using logging frameworks, message queues, etc.). Event log 300 can track performance, detect security incidents, and ensure compliance with one or more security protocols of the enterprise network (e.g., system 100). By maintaining event log 300 as a structured data source, event database 146 can support device/document compliance auditing, access control enforcement, and security monitoring for system 100. Furthermore, information logged for the event can be used to track document (e.g., encoded document copy) movement, detect unauthorized access attempts, enforce document retention and sharing policies effectively, and perform other tasks, using information derived from event log 300.

Event log 300 can operate as a centralized repository where events are recorded sequentially, often using a logging framework or event-streaming service. Some examples of such logging frameworks/event-streaming services include Apache Kafka, AWS Kinesis, or a traditional relational database. Each event notification of event log 300 may include an event identifier, a timestamp, a requesting device identifier (e.g., Mobile_User_N, Mobile_User_(N-1), . . . , Mobile_User_1), a requested document identifier (e.g., Ref_Id_N, Ref_Id_(N-1), . . . , Ref_Id_1), a description of the event, and/or other metadata relevant to the event's context. For example, as seen in FIG. 3, event log 300 may include event notifications corresponding to events E1 thru EN. In the example illustrated in FIG. 3, the event notifications are presented in order of the most recent event, however other organizational methods can be used to display the events of the event log.

Event log 300 can collect event notifications of events from different system components (e.g., entitled client device 110, non-entitled client device 120) and publish them for further processing. Event notifications can be pushed to event log 300 via real-time through API calls or system hooks, allowing for immediate monitoring and analysis. Event log 300 can enable auditing, troubleshooting, and compliance enforcement by maintaining a historical record of interactions within the computing network (e.g., system 100). Additionally, event notifications in event log 300 can trigger automated workflows, such as updating a retrieval database (e.g., retrieval database 148), alerting security systems (e.g., automated computer program 104), and/or enforcing data retention policies (e.g., using enforcement system 106).

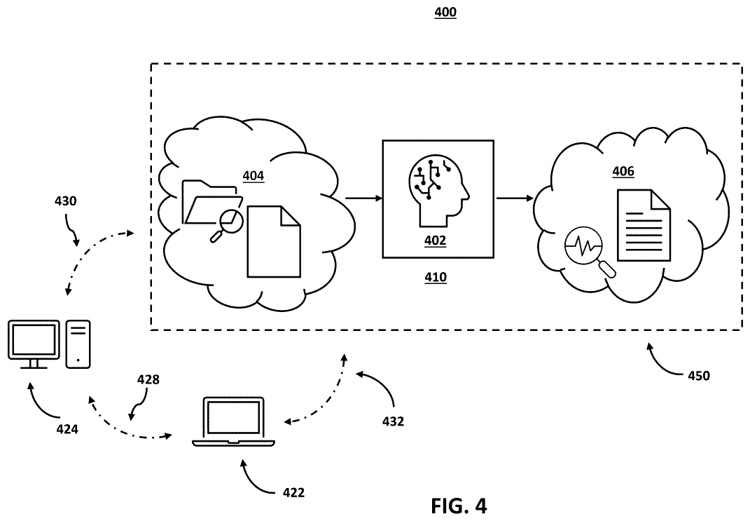

FIG. 4 shows illustrative components of a system used to track and enforce data authorization conditions in a computing network, in accordance with one or more embodiments. For example, FIG. 4 may show illustrative components for tracking and enforcing data authorization conditions in an enterprise network (e.g., system 100). As shown in FIG. 4, system 400 may include mobile device 422 and user terminal 424. While shown as a smartphone and personal computer, respectively, in FIG. 4, it should be noted that mobile device 422 and user terminal 424 may be any computing device, including, but not limited to, a laptop computer, a tablet computer, a hand-held computer, and other computer equipment (e.g., a server), including “smart,” wireless, wearable, and/or mobile devices. In some examples, mobile device 422 and/or user terminal 424 may correspond to entitled client device 110, non-entitled client device 120, end user device 130, or other components of system 100. FIG. 4 also includes cloud components 410. Cloud components 410 may alternatively be any computing device as described above, and may include any type of mobile terminal, fixed terminal, or other device. For example, cloud components 410 may be implemented as a cloud computing system and may feature one or more component devices. It should also be noted that system 400 is not limited to three devices. Users may, for instance, utilize one or more devices to interact with one another, one or more servers, or other components of system 400. It should be noted, that, while one or more operations are described herein as being performed by particular components of system 400, these operations may, in some embodiments, be performed by other components of system 400. As an example, while one or more operations are described herein as being performed by components of mobile device 422, these operations may, in some embodiments, be performed by components of cloud components 410. In some embodiments, the various computers and systems described herein may include one or more computing devices that are programmed to perform the described functions. Additionally, or alternatively, multiple users may interact with system 400 and/or one or more components of system 400. For example, in one embodiment, a first user and a second user may interact with system 400 using two different components.

With respect to the components of mobile device 422, user terminal 424, and cloud components 410, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., document copies, data authorization results, messages/notifications/alerts, etc.).

Additionally, as mobile device 422 and user terminal 424 are shown as touchscreen smartphones, these displays also function as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 400 may run an application (or another suitable program). The application may cause the processors and/or control circuitry to perform operations related to generating dynamic conversational replies, queries, and/or notifications.

Each of these devices may also include electronic storage. The electronic storages may include non-transitory storage media that electronically store information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice, or data network (e.g., a 5G or LTE network), a cable network, a public switched telephone network, or other types of communications networks or combinations of communications networks. Communication paths 428, 430, and 432 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may include computing system 102, automated computer program 104, enforcement system 106, or other components of system 100. Cloud components 410 may include model 402, such as a machine learning model used to perform matching/searching for encrypted-reference identifier mappings and/or event mappings, a machine learning model employed by non-entitled client device 120 (or end user device 130) executing machine learning tasks, or other models (which may be referred to collectively as “models” herein). Model 402 may take inputs 404 and provide outputs 406. The inputs may include multiple datasets, such as a training dataset and a test dataset. Each of the plurality of datasets may include data subsets related to user data, predicted forecasts and/or errors, and/or actual forecasts and/or errors. In some embodiments, outputs 406 may be fed back to model 402 as input to train model 402 (e.g., alone or in conjunction with user indications of the accuracy of outputs 406, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a class of computing tasks to be executed).

In a variety of embodiments, model 402 may update its configurations (e.g., weights, biases, or other parameters) based on the assessment of its prediction (e.g., outputs 406) and reference feedback information (e.g., user indication of accuracy, reference labels, or other information). In a variety of embodiments, where model 402 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 402 may be trained to generate better predictions.

In some embodiments, model 402 may include an artificial neural network. In such embodiments, model 402 may include an input layer and one or more hidden layers. Each neural unit of model 402 may be connected with many other neural units of model 402. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 402 may be self-learning and trained, rather than explicitly programmed, and can perform significantly better in certain areas of problem solving, as compared to traditional computer programs. During training, an output layer of model 402 may correspond to a classification of model 402, and an input known to correspond to that classification may be input into an input layer of model 402 during training. During testing, an input without a known classification may be input into the input layer, and a determined classification may be output.

In some embodiments, model 402 may include multiple layers (e.g., where a signal path traverses from front layers to back layers). In some embodiments, back propagation techniques may be utilized by model 402 where forward stimulation is used to reset weights on the “front” neural units. In some embodiments, stimulation, and inhibition for model 402 may be more free flowing, with connections interacting in a more chaotic and complex fashion. During testing, an output layer of model 402 may indicate whether a given input corresponds to a classification of model 402 (e.g., a data item is relevant to the computing task to be executed).

In some embodiments, the model (e.g., model 402) may automatically perform actions based on outputs 406. In some embodiments, the model (e.g., model 402) may not perform any actions. The output of the model (e.g., model 402) may be used to further update the model by generating updated training data, including the input request and the predicted classification.

System 400 also includes API layer 450. API layer 450 may allow the system to generate summaries across different devices. In some embodiments, API layer 450 may be implemented on mobile device 422 or user terminal 424 (e.g., entitled client device 110, non-entitled client device 120, end user device 130). Alternatively, or additionally, API layer 450 may reside on one or more of cloud components 410 (e.g., computing system 102, enforcement system 106, databases 140, etc). API layer 450 (which may be a REST, Web services API layer, GraphQL layer) may provide a decoupled interface to data and/or functionality of one or more applications. API layer 450 may provide a common, language-agnostic way of interacting with an application. Web service APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web-services, using resources like Service Repository and Developer Portal, but with low governance, standardization, and separation of concerns. Alternatively, system 400 may be fully based on API layer 450, such that separation of concerns between layers like API layer 450, services, and applications is in place.

In some embodiments, the system architecture may use a microservice approach. Such systems may use two types of layers: Front-End Layer and Back-End Layer where microservices reside. In this kind of architecture, the role of the API layer 450 may provide integration between Front-End and Back-End. In such cases, API layer 450 may use RESTful APIs (exposition to front-end or even communication between microservices). API layer 450 may use AMQP (e.g., Kafka, RabbitMQ, etc.). API layer 450 may use incipient usage of new communications protocols such as gRPC, Thrift, etc.

In some embodiments, the system architecture may use an open API approach. In such cases, API layer 450 may use commercial or open-source API Platforms and their modules. API layer 450 may use a developer portal. API layer 450 may use strong security constraints applying WAF and DDoS protection, and API layer 450 may use RESTful APIs as standard for external integration.

As another example, instead of using RESTful APIs, a GraphQL API may be used, as mentioned above. Differing from RESTful systems, GraphQL can specify a single endpoint to provide requests. GraphQL uses a schema to indicate the different types of data that is included in a given sub-graph, the relationships of that data, and operations that can be performed on the data. The operations include, for example, query operations to retrieve data, mutation operations to modify data, and subscription operations.

In some embodiments, system 400 may include an Application-Specific Integrated Circuit (ASIC). An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. As an example, one or more components of system 100 (e.g., computing system 102, automated computer program 104, enforcement system 106, etc.) may be implemented using one or more ASICs.

ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, system 400 may use weight quantization, memory hierarchy optimization, and on-chip interconnects can be employed to improve throughput and reduce power consumption. To accommodate large models, system 400 may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, system 400 may use field-programmable gate arrays (FPGAs) or GPUs during the training phase, then transfer the trained model weights to the ASIC for inference. Alternatively, system 400 may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

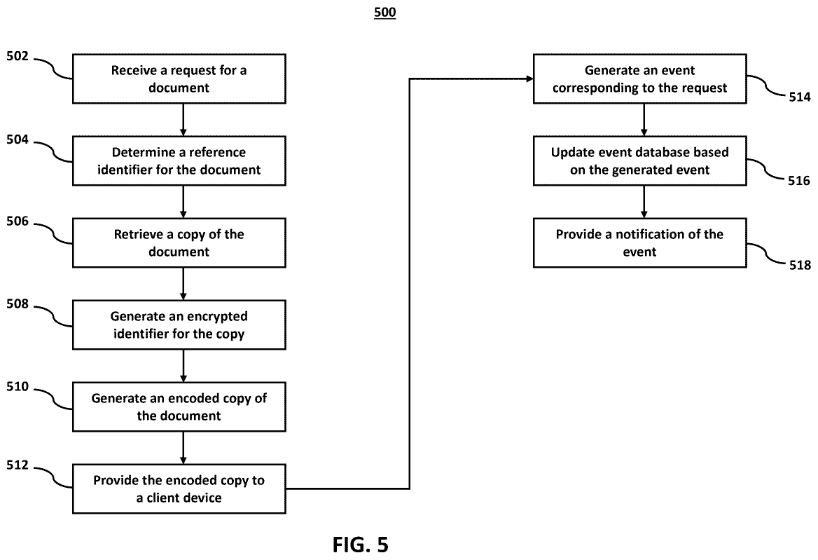

FIG. 5 shows an illustrative flowchart of an example process 500 for tracking documents and compliance within a computing network, in accordance with one or more embodiments. For example, system 100 of FIG. 1 and/or system 400 of FIG. 4 may use process 500 (e.g., as implemented on one or more system components described above) in order to monitor security protocol compliance within an enterprise network. In some embodiments, process 500 may implement authorization conditions within a computing network to improve network security by tracking document retrieval requests and responses across the computing network using embedded encodings. Data authorization conditions (e.g., data authorization condition 222) can include one or more rules (e.g., rules 224). These rules form the basis for determining whether a given document and/or client device comply with the network's security protocols. In some examples, data authorization conditions 220 can include/specify one or more document and information retention enforcement policies forming security protocols of the enterprise computing network (e.g., system 100 of FIG. 1). These document/information retention policies can ensure device compliance, data security, and efficient data management.

The rules specify how a document can remain in compliance with data authorization conditions, and thus the security protocols of the computing network. For example, the rules may indicate a time-based retention policy, an access-controlled retention policy, a legal hold retention policy, an automated expiry and deletion retention policy, a versioning and audit log retention policy, an encryption and secure disposal retention policy, or other policies, or combinations thereof, applicable for a given data authorization condition.

Process 500 may begin, for example, at step 502. In some embodiments, step 502 may include a request for a document being received. For example, computing system 102 may be configured to receive a request from a client device (e.g., entitled client device 110, non-entitled client device 120, etc.). In some examples, the request may be a document retrieval request. A document retrieval request can include a request, submitted by a client device (e.g., via an API call), for a document. In particular, the request may be for a copy of a document. In some cases, documents may remain centrally stored, such as by document database 142. When a document is requested, upon determining that the document is allowed to be shared with the requesting device, a copy of that document may be created. The copy of the document may be identical to the original version of the document (i.e., the raw document initially provided to document database 142 for storage by a document owner, such as entitled client device 110). In some embodiments, the request may include a document identifier. For example, the document identifier included in the request may be a reference identifier (e.g., such as reference identifier 204) of a document stored in document database 142. Alternatively, a different document identifier, keyword, resource locator address, or other identification mechanism may be used to indicate which document is being requested. In some embodiments, the request may further include information about the requesting device. For example, the request may include a device identifier of the requesting device (e.g., entitled client device 110, non-entitled client device 120, end user device 130, etc.). The device identifier may include a MAC address, serial number, IP address, account number (e.g., of an account with computing system 102 associated with the client device), communication identifier (e.g., mobile phone number, email address, etc.), or other identification mechanism.

At step 504, a reference identifier for the document may be determined. The reference identifier may be determined based on the request. For example, as mentioned above, the request may include a document identifier of a requested document. The request may be submitted as an API call (e.g., using a GET operation) to document database 142. Computing system 102 may receive the request and parse the request to determine a document identifier, if any, included in the request. Using the document identifier from the request, computing system 102 may be configured to determine whether the document identifier matches any reference identifiers of documents stored by document database 142.

At step 506, a copy of the document may be received. In some embodiments, the copy of the document may be retrieved from document database 142 based on the reference identifier. For example, if the document identifier corresponds to the reference identifier, computing system 102 may access document database 142 by submitting API calls to document database 142. The API calls may include query operations to search across document data 200 for a reference identifier (e.g., reference identifier 204) of a document (e.g., document 202) stored by document database 142 matching the document identifier included in the request.

At step 508, an encrypted identifier for the copy may be generated. An encrypted identifier for the document copy can be generated for each document retrieval request made. The encrypted identifier can uniquely mark a copy of a given document (e.g., in response to a document retrieval request). In some embodiments, the encrypted identifier (e.g., encrypted identifier 206) can be generated using a cryptographic algorithm to a unique document reference. For example, reference identifier 204 of document 202 (e.g., a UUID, a database ID, etc.) can be used to generate encrypted identifier 206 by encrypting reference identifier 204 using a symmetric or asymmetric encryption method, such as AES or RSA, along with a secret key or public-private key pair. The created encrypted identifier (e.g., encrypted identifier 206) can be used to track or verify document copies while preventing unauthorized access to the original document (e.g., document 202) or sharing the reference identifier assigned to the document. In some embodiments, additional information may be used in conjunction with, or instead of, the reference identifier (e.g., reference identifier 204) to generate the encrypted identifier (e.g., encrypted identifier 206). For example, if the encrypted identifier is generated in response to a document retrieval request, a device identifier, account identifier, request identifier, authorization condition identifier(s), or other information, can be used instead of or in addition to the reference identifier (e.g., reference identifier 204) to generate the encrypted identifier (e.g., encrypted identifier 206). As an illustrative example, if reference identifier 204 is represented as a 10-character alphanumeric string (e.g., A1B2C3D4E5), an encryption algorithm (e.g., Advanced Encryption Standard (AES)-256 encryption) can be used with a secret key (e.g., MySecretKey12445) to create encrypted identifier 206 (e.g., 7F8G92KLMN). Although AES-256 encryption is described in the previous example, other encryption techniques, including, but not limited to, Rivest-Shamir-Adleman (RSA), Data Encryption Standard (DES), Triple DES (3DES), Elliptic Curve Cryptography (ECC), and/or Blowfish.

At step 510, an encoded copy of the document may be generated. The encoded copy of the document may include the encrypted identifier. In some embodiments, the encoded copy of the document may be generated as a response to the request. In some embodiments, generating the encoded copy of the document may include encoding the retrieved copy of the document with the encrypted identifier. In some embodiments, computing system 102 encoding the copy of the document with the encrypted identifier may include computing system 102 generating a hash based on the reference identifier. Computing system 102 may assign the hash to be the encrypted identifier. Computing system 102 may add the encrypted identifier to the copy to create the encoded copy.

The encrypted identifier can be added to the copy of the document in a variety of ways. For example, computing system 102 can add the encrypted identifier as a header or text field to the copy. As another example, computing system 102 can mark the copy with the encrypted identifier. As yet another example, computing system 102 can add the encrypted identifier by appending the encrypted identifier to the copy as metadata. In some embodiments, computing system 102 encoding the copy with the encrypted identifier may include computing system 102 to generate a machine-readable code (e.g., using a barcode, QR code, etc.) representing the encrypted identifier. The machine-readable code may be added to the copy of the document (e.g., incorporated into, embedded into, etc.).

At step 512, the encoded copy of the document may be provided to a client device. In some embodiments, the encoded copy of the document may be provided to the client device that requested the document (e.g., entitled client device 110, non-entitled client device 120). The encoded copy of the document may be provided as a response to the request. For example, the encoded copy may be included in an API message responding to an API call for the document (e.g., the document retrieval request).

At step 514, an event corresponding to the request may be generated. In some embodiments, the event can relate to a type of document transaction (e.g., a document retrieval request, a document sharing request, a document copying request, etc.). Each event (e.g., event 232) can include an event identifier (e.g., event identifier 234), an event mapping (e.g., event mapping 236), a device identifier (e.g., device identifier 238), or other information, or combinations thereof.

At step 516, an event database may be updated based on the generated event. In some embodiments, the event database may be updated to include the event. The event may include an event mapping of the encrypted identifier to the document (e.g., the reference identifier of the document), a device identifier of the client device (e.g., the requesting device). In some embodiments, updating the event database may include computing system 102 generating an event record for the event. The event record may include the event mapping, the device identifier, and/or other information. In some embodiments, the event record may be added to a plurality of event records. For example, the event record may be added to the event log (e.g., event log 300) including records of other document retrieval requests..

At step 518, a notification of the event can be provided. In some embodiments, the notification can be provided to the computing network. For example, the enterprise network (e.g., system 100) may provide a notification of the update to event database 146 to some or all of the components of the network. In some implementations, the notification can be provided to the client device (e.g., the request device). In some embodiments, computing system 102 providing the notification may include publishing the notification to an event log comprising events associated with previously received document retrieval requests. For example, the notification may indicate the new event that occurred and the event record created for that event. In some embodiments, enterprise components may be able to access the event log. For example, entitled client device 110, non-entitled client device 120, and/or other components of system 100, may have access to event log 300.

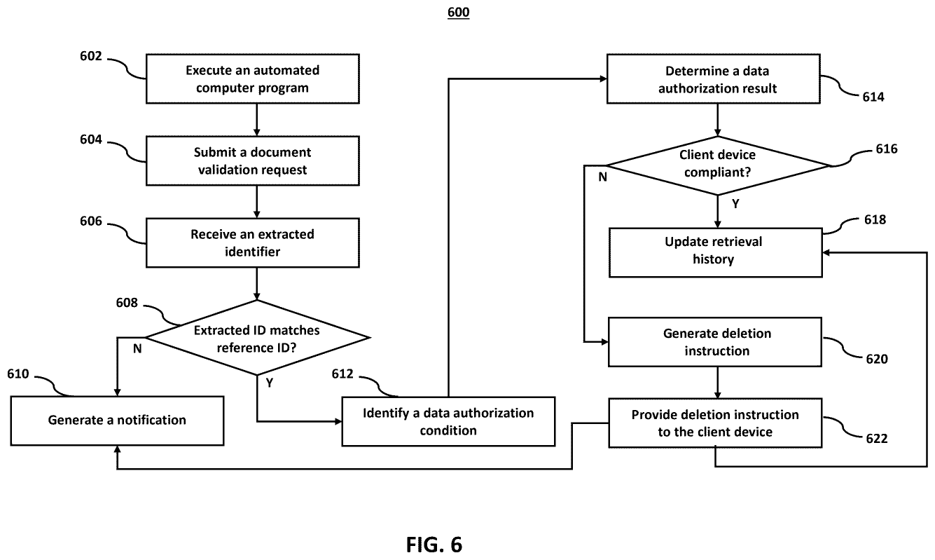

FIG. 6 shows an illustrative flowchart of an example process 600 for determining a data authorization result for data authorization condition enforcement, in accordance with one or more embodiments. In some embodiments, process 600 may implement enforcement of security protocols within a computing network to improve network security.

At step 602, an automated computer program may be executed. In some embodiments, the automated computer program may be executed subsequent to a notification being provided to the computing network (e.g., system 100). For example, subsequent to the notification being provided to the client device (e.g., step 518), automated computer program 104 may be executed. In some embodiments, the automated computer program may be executed to determine whether the client device complies with one or more security protocols of the computing network.

In some embodiments, the automated computer program may be executed based on a determined that a predefined amount of time has elapsed since the encoded copy was provided to the client device. For example, computing system 102 may be configured to trigger execution of automated computer program 104 based on a predefined amount of time (e.g., a few seconds, a few minutes, a few hours, etc.) elapsing since an encoded copy of a document was provided to a client device as a response to a document retrieval request. In some embodiments, the automated computer program may be executed at a predefined cadence (e.g., hourly, daily, weekly, etc.). In some examples, the automated computer program may be executed based on a user input (e.g., a request to execute automated computer program 104).

In some embodiments, the automated computer program being executed may include the automated computer program submitting document validation requests to client devices of the computing network. For example, wherein automated computer program 104 may submit the document validation requests via application programming interface (API) requests.

In an example where the computing network (e.g., system 100) includes one or more entitled client devices (e.g., entitled client device 110) and one or more non-entitled client devices (e.g., non-entitled client device 120), the automated computer program (e.g., automated computer program 104) being executed may include providing, to the non-entitled client devices, document validation requests. The document validation requests may be used to determine whether the non-entitled client devices comply with the one or more security protocols, as specified by the data authorization conditions.

At step 604, a document validation request may be submitted. In some embodiments, the document validation requests may be submitted to some or all of the client devices of the computing network. For example, automated computer program 104 may submit document validation requests to entitled client device 110, non-entitled client device 120, end user device 130, and/or other components of system 100. In some embodiments, the document validation requests may include additional information, data, software, etc. For example, one or more artificial intelligence models may be provided to the client device to extract one or more document identifiers from documents stored in the memory. The document identifiers may include (or may be expected to include) the extracted document identifier.

At step 606, an extracted identifier may be received. In some embodiments, based on the automated computer program (e.g., automated computer program 104), computing system 102 may be configured to receive the extracted document identifier. The extracted document identifier may be received from the client device. In some examples, the extracted document identifier may correspond to a document identifier of a document stored in memory of the client device.

At step 608, a determination may be made as to whether the extracted identifier matches a known reference identifier. For example, the extracted document identifier may be used to query against encrypted identifiers stored in reference-encrypted identifier mappings 210. In some embodiments, the matching process may include comparing the extracted document identifier against one or more stored encrypted identifiers, related to previously submitted document transaction requests. The matching process may include an exact matching (e.g., exact character string matching) or a partial matching (e.g., at least a threshold number of characters in the string match).

If, at step 608, computing system 102 determines that the extracted identifier does not match any known reference identifier, process 600 may proceed to step 610. For example, the extracted document identifier may be determined to have less than a threshold number of similar characters as any of the encrypted identifiers included in reference-encrypted identifier mappings 210. At step 610, a notification may be generated.

If, at step 608, computing system 102 determines that the extracted identifier matches a known identifier, process 600 may proceed to step 612. For example, the extracted document identifier may be determined to have more than a threshold number of similar characters as an encrypted identifier included in reference-encrypted identifier mappings 210. At step 612, a data authorization condition can be identified. In some embodiments, based on the extracted identifier matching a known identifier, one or more data authorization conditions associated with the known document may be retrieved. For example, based on the matched encrypted identifier, a corresponding reference identifier (e.g., reference identifier 204) can be determined. Determining the reference identifier can allow the corresponding document (e.g., document 202) to be identified and, subsequently, the data authorization conditions (e.g., indicated by authorization condition identifier 208) for that document determined.

At step 614, a data authorization result may be determined. In some embodiments, the data authorization result may be determined based on the data authorization condition. In some embodiments, computing system 102 may be configured to determine the data authorization result. To determine the data authorization result, computing system 102 may be configured to determine a first time that the encoded copy was provided to the client device, a second time that the automated computer program was executed, and an amount of time that the encoded copy was stored in the memory based on the first time and the second time. Upon determining the amount of time, computing system 102 may determine whether the client device complies with the data authorization condition. For example, computing system 102 may determine whether the amount of time is less than or equal to a threshold amount of time with which the client device is authorized to retain the encoded copy within the memory. If the amount of time is determined to be less than or equal to the threshold amount of time, the data authorization result may indicate that the client device complies with the security protocols. However, if the amount of time is determined to be greater than the threshold amount of time, the data authorization result may indicate that the client device fails to comply with the security protocols.

In some embodiments, computing system 102 may be configured to determine the data authorization result. To determine the data authorization result, computing system 102 may be configured to receive, from the client device, based on the automated computer program, a document copy message indicating that the client device created an additional copy of the document and provided the additional copy to a separate device. For example, computing system 102 may receive a document copy message indicating that non-entitled client device 120 provided the document copy to end user device 130. The data authorization condition associated with the document can indicate whether non-entitled client device 120 is authorized to provide the document copy to end user device 130, whether end user device 130 is authorized to receive document copies, whether the document copy is authorized to be provided to any other device, or other conditions. As an example, a document authorization condition may indicate that non-entitled client device 120 lacks authorization to provide the document copy to any other device in the enterprise network. As another example, a document authorization condition may indicate that non-entitled client device 120 lacks authorization to create an additional copy of the encoded document and/or provide the additional copy to the separate device (e.g., end user device). In some embodiments, computing system 102 may generate the data authorization result to indicate whether the client device complied with the data authorization conditions (e.g., security protocols). For example, if computing system 102 determines that the client device lacked authorization to generate and provide an additional copy of the encoded copy of the document to another device, then the data authorization result may indicate that the client device failed to comply with the security protocols. Alternatively, if computing system 102 determines the client device has authorization to generate and provide an additional copy of the encoded copy of the document to another device, then the data authorization result may indicate that the client device failed to comply with the security protocols.

In some embodiments, computing system 102 may deploy software agents to client devices of the computing network. For example, entitled client device 110 may include agent 116 stored in memory. In some embodiments, entitled client device 110 may be configured to determine data authorization results for the client devices at a predefined cadence. For example, agent 116 may include an internal timing mechanism that causes document copies stored in memory 114 to be analyzed, encrypted identifiers extracted and provided to automated computer program 104 (and/or computing system 102), and determinations of client device compliance performed based on the extracted identifiers and data authorization conditions determined to be associated with documents having reference identifiers matching the extracted identifiers. In some embodiments, automated computer program 104 may leverage computing system 102 to access databases 140 to identify a document, data authorization conditions, and/or other information to perform security protocol enforcement.

In some embodiments, the data authorization condition being satisfied may include a memory usage amount of the client device being less than or equal to a threshold memory usage amount. In this example, determining the data authorization result may include computing system 102 determining whether the memory usage amount of the client device is less than or equal to the threshold memory usage amount. If the memory usage amount is determined to be greater than the threshold memory usage amount, this may indicate that the client device is not compliant with the data authorization condition. Thus, if the data authorization result indicates that the client device fails to comply with the data authorization condition, then computing system 102 may determine that the client device fails to comply with the security protocols.

At step 616, a determination may be made as to whether the client device is compliant. The data authorization result, for example, may indicate whether the client device complies with the security protocols (i.e., is compliant).

If, at step 616, computing system 102 determines that the client device is not compliant with one or more data authorization conditions, process 600 may proceed to step 620. For example, the authorization condition associated with a document may indicate whether the client device is authorized to retain a copy of the document in its memory for a threshold amount of time. If the document copy has been stored by the document for more than the threshold amount of time, then this may indicate that the client device has not complied with the data authorization condition. Therefore, the client device, in this example, would not be compliant with the security protocols of the computing network.

At step 620, a deletion instruction may be generated. In some embodiments, enforcement system 106 may generate the deletion instruction and provide the deletion instruction to the client device (e.g., entitled client device 110, non-entitled client device 120). Enforcement system 106 may leverage software components and/or hardware components of computing system 102 to generate and provide the deletion instruction. Alternatively, in some embodiments, computing system 102 may generate the deletion instruction and provide the deletion instruction to the client device or enforcement system (for providing to the client device).

At step 622, the deletion instruction may be provided to the client device.

Process 600 may proceed from step 622 to step 610 based on the deletion instruction being provided to the client device. In some embodiments, the notification generated at step 610 (subsequent to step 622) may include notification of the deletion instruction being provided to the client device. In some embodiments, the notification may include a document compliance notification. For example, computing system 102 may provide a document compliance notification to the client device based on the data authorization result indicating that the client device is compliant with the data authorization condition.

In some embodiments, computing system 102 may be configured to provide the document compliance notification. In some examples, computing system 102 may cause enforcement system 106 to provide the document compliance notification. In some embodiments, providing the document compliance notification may include a deletion instruction to delete the encoded copy from the memory of the client device be generated and provided to the client device. The deletion instruction may be generated based on the data authorization result indicating that the client device failed to comply with the security protocols. In some embodiments, providing the deletion instruction may include receiving a deletion confirmation message from the client device indicating that the encoded copy has been deleted from the memory. For example, upon the document copy being deleted by the client device, a response message may be provided to computing system 102.

In some embodiments, computing system 102 may be configured to provide the document compliance notification. In some examples, computing system 102 may cause enforcement system 106 to provide the document compliance notification. In some embodiments, providing the document compliance notification may include a graphical user interface being generated. Computing system 102 may be configured to generate the graphical user interface. In this example, computing system 102 may provide the graphical user interface to the client device or may provide the graphical user interface to the enforcement system, which can provide the graphical user interface to the client device. In some embodiments, the graphical user interface may include a compliance message. The compliance message can indicate whether the client device complies with the security protocols. The graphical user interface may be provided to the client device for display. The graphical user interface may display the compliance message via the client device.

In some embodiments, the authorization condition may include a condition that a copy of a document (i.e., an encoded copy) be stored by a client device for a threshold amount of time or less. In this example, the graphical user interface being provided to the client device may include determining, based on the data authorization condition, an amount of time with which the encoded copy is authorized to be stored in the memory. The graphical user interface displaying the compliance message may indicate the amount of time. In some examples, the graphical user interface may include a dynamic display indicating how much time a copy of a document is authorized to be stored by the client device.

In some embodiments, in addition to or instead of proceeding to step 610, process 600 may proceed from step 622 to step 618. In this example, at step 618, the updated retrieval history may include an indication that the deletion instruction was provided to the client device.

If, however, at step 616, computing system 102 determines that the client device is compliant, process 600 may proceed to step 618.

At step 618, a retrieval history may be updated. In some embodiments, updating the retrieval history may include generating updated mappings and providing those updated mapping to document database 142 from event database 146 and/or retrieval database 148. For example, upon determining that an encoded copy of document 202 was provided to non-entitled client device 120, automated computer program 104 and/or computing system 102 may generate an event mapping indicating that a copy of a document stored on non-entitled client device 120 matches an encrypted identifier previously generated when a copy of a document was requested. In some embodiments, an updated mapping generated by retrieval database 148 may be provided to document database 142 and used to update reference-encrypted identifier mappings 210. For example, the updated mapping may store a relationship between the extracted document identifier, the corresponding encrypted identifier, and the reference identifier matched to the encrypted identifier.

It is contemplated that the steps or descriptions of FIGS. 5 and 6 may be used with any other embodiment of this disclosure. In addition, the steps and descriptions described in relation to FIGS. 5 and 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIGS. 5 and 6.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for implementing and enforcing data authorization conditions.
2. The method of embodiment 1, comprising: receiving, from a client device of a computing network, a request for a document; generating and providing, to the client device as a response to the request, an encoded copy of the document comprising an encrypted identifier; updating an event database to include an event corresponding to the request, the event comprising (1) an event mapping of the encrypted identifier to the document, and (2) a device identifier of the client device; and providing, to the computing network, a notification of the event; executing, subsequent to the notification being provided to the computing network, an automated computer program to determine client device compliance with one or more security protocols of the computing network; receiving, from the client device, based on the automated computer program, an extracted document identifier of a document stored in memory of the client device; retrieving, based on the extracted document identifier matching the encrypted identifier, a data authorization condition associated with the document; determining, based on the data authorization condition, a data authorization result indicating that the client device complies or fails to comply with the one or more security protocols; and providing, to the client device, a document compliance notification based on the data authorization result.
3. The method of any of embodiments 2-4, wherein providing the document compliance notification comprises: generating, based on the data authorization result indicating that the client device fails to comply with the one or more security protocols, a deletion instruction to delete the encoded copy from the memory; and providing the deletion instruction to the client device.
4. The method of embodiment 3, further comprising: receiving, subsequent to the deletion instruction being provided to the client device, a deletion confirmation message indicating that the encoded copy has been deleted from the memory.
5. The method of any one of embodiments 2-4, wherein providing the document compliance notification comprises: generating a graphical user interface comprising a compliance message indicating that the client device complies or fails to comply with the one or more security protocols; and providing the graphical user interface to the client device for display.
6. The method of any one of embodiments 2-5, wherein determining that data authorization result comprises: determining, based on the data authorization condition, a first amount of time with which the encoded copy is authorized to be stored in the memory; computing a second amount of time with which the encoded copy has been stored in the memory; and determining, based on (i) the first amount of time, (ii) the second amount of time, and (iii) the data authorization condition, the data authorization result, wherein providing the document compliance notification comprises: displaying, using a graphical user interface, the compliance message comprising (i) the first amount of time, (ii) the second amount of time, or (iii) a third amount of time determined based on a difference between the first amount of time and the second amount of time.
7. The method of any one of embodiments 2-6, wherein generating and providing the encoded copy comprises: determining a reference identifier associated with the document based on the request; retrieving, based on the reference identifier, a copy of the document from a document database; and encoding the copy of the document with the encrypted identifier to obtain the encoded copy.
8. The method of embodiment 7, wherein encoding the copy with the encrypted identifier comprises: generating a hash based on the reference identifier; and adding the encrypted identifier to the copy to create the encoded copy.
9. The method of embodiment 8, wherein adding the encrypted identifier to the copy to obtain the encoded copy comprises at least one of: adding the encrypted identifier as a header or text field to the copy; marking the copy with the encrypted identifier; or appending the encrypted identifier to the copy as metadata.
10. The method of any one of embodiments 7-9, wherein encoding the copy with the encrypted identifier to obtain the encoded copy comprises: generating a machine-readable code representing the encrypted identifier; and adding the machine-readable code to the copy.
11. The method of any one of embodiments 2-10, wherein updating the event database comprises: generating an event record for the event comprising (1) the event mapping and (2) the device identifier; and adding the event record to a plurality of event records stored by the event database for previously received document retrieval requests.
12. The method of any one of embodiments 2-11, wherein providing the notification comprises: publishing the notification to an event log comprising event notifications associated with previously received document retrieval requests, wherein client devices of the computing network have access to the event log.
13. The method of any of embodiments 2-12, wherein executing the automated computer program comprises: generating a document retrieval request; providing the document retrieval request to the client device; and providing, to the client device, with the document retrieval request, one or more artificial intelligence models to extract one or more document identifiers from documents stored in the memory, wherein the one or more document identifiers comprise the extracted document identifier.
14. The method of any of embodiments 2-13, wherein determining the data authorization result comprises: determining a first time that the encoded copy was provided to the client device; determining a second time that the automated computer program was executed; determining an amount of time that the encoded copy was stored in the memory based on the first time and the second time; determining whether client device complies with the data authorization condition by determining whether the amount of time is less than or equal to a threshold amount of time with which the client device is authorized to retain the encoded copy within the memory, wherein the data authorization result indicates that the client device complies with the one or more security protocols based on the amount of time being less than or equal to the threshold amount of time or the data authorization result indicates that the client device fails to comply with the one or more security protocols based on the amount of time being greater than the threshold amount of time.
15. The method of any of embodiments 2-14, further comprising: receiving, from the client device, a document copy message indicating that the client device created an additional copy of the document and provided the additional copy to a separate device; determining, based on the data authorization condition associated with the document, that the client device lacks authorization to create and provide the additional copy to the separate device; and generating the data authorization result indicating that the client device failed to comply with the one or more security protocols based on the client device lacking authorization to create the additional copy and provide the additional copy to the separate device.
16. The method of any of embodiments 2-15, wherein executing the automated computer program comprises: submitting document validation requests to client devices of the computing network, wherein the document validation requests comprise application programming interface (API) requests.
17. The method of any of embodiments 2-16, further comprising: deploying software agents to client devices of the computing network including the client device, wherein the software agents are configured to determine data authorization results for the client devices at a predefined cadence.
18. The method of any of embodiments 2-17, wherein the computing network comprises entitled client devices and non-entitled client devices, executing the automated computer program comprises: providing, to the non-entitled client devices, document validation requests to determine whether the non-entitled client devices comply with the one or more security protocols, wherein the non-entitled client devices comprise the client device.
19. The method of any of embodiments 2-18, wherein the data authorization condition being satisfied comprises a memory usage amount of the client device being less than or equal to a threshold memory usage amount, determining the data authorization result comprises: determining that the client device fails to satisfy the data authorization condition based on the memory usage amount of the client device being greater than the threshold memory usage amount, wherein the data authorization result indicates that the client device fails to comply with the one or more security protocols based on the memory usage amount of the client device being greater than the threshold memory usage amount.
20. The method of any one of embodiments 2-19, wherein the data authorization conditions being implemented and enforced comprising implementing and enforcing the data authorization conditions within a computing network to improve network security by tracking document retrieval requests and responses across the computing network using embedded encodings.
21. The method of any one of embodiments 2-20, wherein generating and providing the encoded copy comprises: extracting, from the request, a document identifier of the client device; determining a data authorization condition identifier associated with the document identifier; determining, based on the data authorization condition identifier, one or more data authorization conditions to be applied copies of documents provided to the client device; and generating the encrypted identifier using the one or more data authorization conditions.
22. The method of any one of embodiments 2-21, wherein the data authorization conditions are implemented and enforced within a computing network to improve network security by tracking document retrieval requests and responses across the computing network using embedded encodings.
23. The method of any one of embodiments 2-22, further comprising: storing, using cloud-based storage, (i) a document database storing documents comprising private data, reference identifiers respectively associated with the documents, and data authorization conditions respectively associated with the documents, (ii) a compliance database comprising data authorization conditions used to verify client device compliance with security protocols of an enterprise network comprising a plurality of client devices, and (iii) an event database storing events associated with document retrieval requests.
24. The method of embodiment 23, further comprising: using cloud-based control circuitry, responsive to receiving, from a client device of the plurality of client devices, at a first time, a request for a document of the documents stored by the document database, generate an encoded copy of the document by embedding an encrypted identifier into the document; provide the encoded copy of the document to the client device as a response to the request; update the events stored by the event database to include an event corresponding to the request, the event comprising (1) an event mapping of the encrypted identifier to a reference identifier of the document, (2) a device identifier of the client device, and (3) a timestamp of the first time when the request was received; and generate and output, to the plurality of client devices, a notification of the event; execute, at a second time subsequent the first time, an automated computer program that submits a document validation request to the client device; receive, from the client device, based on the document validation request, a document identifier of a document copy stored in memory of the client device, wherein the document validation request causes one or more artificial intelligence models to be executed to the document copy to extract the document identifier; responsive to determining, based on the event mapping, that the document identifier corresponds to the encrypted identifier, retrieve, from the compliance database, a data authorization condition associated with the encoded copy of the document, wherein satisfying the data authorization condition comprises determining that the document copy has been stored in the memory for less than a threshold amount of time; and responsive to determining that encoded copy of the document fails to satisfy the data authorization condition based on an amount of time, computed using the first time and the second time, being greater than the threshold amount of time, generate deletion instructions to delete the encoded copy of the document from the memory of the client device.
25. The method of embodiment 24, further comprising: causing, using cloud-based I/O circuitry, a graphical user interface comprising a notification to be displayed indicating that the client device failed to satisfy the data authorization condition and that the encoded copy of the document has been deleted.
26. One or more non-transitory, computer-readable mediums storing instructions that, when executed by a data processing apparatus, cause the data processing apparatus to perform operations comprising those of any of embodiments 1-25.
27. A system comprising one or more processors; and memory-storing instructions that, when executed by the processors, cause the processors to effectuate operations comprising those of any of embodiments 1-25.
28. A system comprising means for performing any of embodiments 1-25.

What is claimed is:

1. A system for implementing and enforcing data authorization conditions within a computing network to improve network security by tracking document retrieval requests and responses across the computing network using embedded encodings, the system comprising:
cloud-based storage comprising (i) a document database storing documents comprising private data, reference identifiers respectively associated with the documents, and data authorization conditions respectively associated with the documents, (ii) a compliance database comprising data authorization conditions used to verify client device compliance with security protocols of an enterprise network comprising a plurality of client devices, and (iii) an event database storing events associated with document retrieval requests;
cloud-based control circuitry configured to:
responsive to receiving, from a client device of the plurality of client devices, at a first time, a request for a document of the documents stored by the document database, generate an encoded copy of the document by embedding an encrypted identifier into the document;
provide the encoded copy of the document to the client device as a response to the request;
update the events stored by the event database to include an event corresponding to the request, the event comprising (1) an event mapping of the encrypted identifier to a reference identifier of the document, (2) a device identifier of the client device, and (3) a timestamp of the first time when the request was received; and
generate and output, to the plurality of client devices, a notification of the event;
execute, at a second time subsequent the first time, an automated computer program that submits a document validation request to the client device;
receive, from the client device, based on the document validation request, a document identifier of a document copy stored in memory of the client device, wherein the document validation request causes one or more artificial intelligence models to be executed to the document copy to extract the document identifier;
responsive to determining, based on the event mapping, that the document identifier corresponds to the encrypted identifier, retrieve, from the compliance database, a data authorization condition associated with the encoded copy of the document, wherein satisfying the data authorization condition comprises determining that the document copy has been stored in the memory for less than a threshold amount of time; and
responsive to determining that encoded copy of the document fails to satisfy the data authorization condition based on an amount of time, computed using the first time and the second time, being greater than the threshold amount of time, generate deletion instructions to delete the encoded copy of the document from the memory of the client device; and
cloud-based I/O circuitry configured to cause a graphical user interface comprising a notification to be displayed indicating that the client device failed to satisfy the data authorization condition and that the encoded copy of the document has been deleted.

2. A method, implemented using one or more processors of a computing system, comprising:
receiving, from a client device of a computing network, a request for a document;
generating and providing, to the client device as a response to the request, an encoded copy of the document comprising an encrypted identifier;
updating an event database to include an event corresponding to the request, the event comprising (1) an event mapping of the encrypted identifier to the document, and (2) a device identifier of the client device; and
providing, to the computing network, a notification of the event;
executing, subsequent to the notification being provided to the computing network, an automated computer program to determine client device compliance with one or more security protocols of the computing network;
receiving, from the client device, based on the automated computer program, an extracted document identifier of a document stored in memory of the client device;
retrieving, based on the extracted document identifier matching the encrypted identifier, a data authorization condition associated with the document;
determining, based on the data authorization condition, a data authorization result indicating that the client device complies or fails to comply with the one or more security protocols; and
providing, to the client device, a document compliance notification based on the data authorization result.

3. The method of claim 2, wherein providing the document compliance notification comprises:
generating, based on the data authorization result indicating that the client device fails to comply with the one or more security protocols, a deletion instruction to delete the encoded copy from the memory; and
providing the deletion instruction to the client device.

4. The method of claim 3, further comprising:
receiving, subsequent to the deletion instruction being provided to the client device, a deletion confirmation message indicating that the encoded copy has been deleted from the memory.

5. The method of claim 2, wherein providing the document compliance notification comprises:
generating a graphical user interface comprising a compliance message indicating that the client device complies or fails to comply with the one or more security protocols; and
providing the graphical user interface to the client device for display.

6. The method of claim 2, wherein determining that data authorization result comprises:
determining, based on the data authorization condition, a first amount of time with which the encoded copy is authorized to be stored in the memory;
computing a second amount of time with which the encoded copy has been stored in the memory; and
determining, based on (i) the first amount of time, (ii) the second amount of time, and (iii) the data authorization condition, the data authorization result, wherein providing the document compliance notification comprises:
displaying, using a graphical user interface, a compliance message comprising (i) the first amount of time, (ii) the second amount of time, or (iii) a third amount of time determined based on a difference between the first amount of time and the second amount of time.

7. The method of claim 2, wherein generating and providing the encoded copy comprises:
determining a reference identifier associated with the document based on the request;
retrieving, based on the reference identifier, a copy of the document from a document database; and
encoding the copy of the document with the encrypted identifier to obtain the encoded copy.

8. The method of claim 7, wherein encoding the copy with the encrypted identifier comprises:
generating a hash based on the reference identifier; and
adding the encrypted identifier to the copy to create the encoded copy, wherein the encrypted identifier is at least one of: added as a header or text field to the copy, marked to the copy, or appended to the copy as metadata.

9. The method of claim 7, wherein encoding the copy with the encrypted identifier to obtain the encoded copy comprises:
generating a machine-readable code representing the encrypted identifier; and
adding the machine-readable code to the copy.

10. The method of claim 2, wherein generating and providing the encoded copy comprises:
extracting, from the request, a device identifier of the client device;
determining a data authorization condition identifier associated with the device identifier;
determining, based on the data authorization condition identifier, one or more data authorization conditions to be applied copies of documents provided to the client device; and
generating the encrypted identifier using the one or more data authorization conditions.

11. The method of claim 2, wherein updating the event database comprises:
generating an event record for the event comprising (1) the event mapping and (2) the device identifier; and
adding the event record to a plurality of event records stored by the event database for previously received document retrieval requests.

12. The method of claim 2, wherein providing the notification comprises:
publishing the notification to an event log comprising event notifications associated with previously received document retrieval requests, wherein client devices of the computing network have access to the event log.

13. The method of claim 2, wherein executing the automated computer program comprises:
generating a document retrieval request;
providing the document retrieval request to the client device; and
providing, to the client device, with the document retrieval request, one or more artificial intelligence models to extract one or more document identifiers from documents stored in the memory, wherein the one or more document identifiers comprise the extracted document identifier.

14. The method of claim 2, wherein determining the data authorization result comprises:
determining a first time that the encoded copy was provided to the client device;
determining a second time that the automated computer program was executed;
determining an amount of time that the encoded copy was stored in the memory based on the first time and the second time;
determining whether client device complies with the data authorization condition by determining whether the amount of time is less than or equal to a threshold amount of time with which the client device is authorized to retain the encoded copy within the memory, wherein the data authorization result indicates that the client device complies with the one or more security protocols based on the amount of time being less than or equal to the threshold amount of time or the data authorization result indicates that the client device fails to comply with the one or more security protocols based on the amount of time being greater than the threshold amount of time.

15. The method of claim 2, further comprising:
receiving, from the client device, a document copy message indicating that the client device created an additional copy of the document and provided the additional copy to a separate device;
determining, based on the data authorization condition associated with the document, that the client device lacks authorization to create and provide the additional copy to the separate device; and
generating the data authorization result indicating that the client device failed to comply with the one or more security protocols based on the client device lacking authorization to create the additional copy and provide the additional copy to the separate device.

16. The method of claim 2, wherein executing the automated computer program comprises:
submitting document validation requests to client devices of the computing network, wherein the document validation requests comprise application programming interface (API) requests.

17. The method of claim 2, further comprising:
deploying software agents to client devices of the computing network including the client device, wherein the software agents are configured to determine data authorization results for the client devices at a predefined cadence.

18. The method of claim 2, wherein the computing network comprises entitled client devices and non-entitled client devices, executing the automated computer program comprises:
providing, to the non-entitled client devices, document validation requests to determine whether the non-entitled client devices comply with the one or more security protocols, wherein the non-entitled client devices comprise the client device.

19. The method of claim 2, wherein the data authorization condition being satisfied comprises a memory usage amount of the client device being less than or equal to a threshold memory usage amount, determining the data authorization result comprises:
determining that the client device fails to satisfy the data authorization condition based on the memory usage amount of the client device being greater than the threshold memory usage amount, wherein the data authorization result indicates that the client device fails to comply with the one or more security protocols based on the memory usage amount of the client device being greater than the threshold memory usage amount.

20. One or more non-transitory computer-readable media storing computer program instructions that, when executed using one or more processors, effectuate operations comprising:
based on an automated computer program being executed to determine whether a client device of a computing network complies with one or more security protocols, receiving, from the client device, a document identifier extracted from a document stored in memory of the client device;
based on the document identifier matching an encrypted identifier of an encoded copy of a document, retrieving a data authorization condition associated with the encoded copy;
determining, based on the data authorization condition, a data authorization result indicating that the client device complies or fails to comply with the one or more security protocols; and
providing, to the client device, a document compliance notification based on the data authorization result.
